(19) United States
(12) Patent Application Publication
(10) Pub. No.: US 2021/0299760 A1
(43) Pub. Date: Sep. 30, 2021

(54) DRILLING TOOL

(71) Applicant: ZHUZHOU CEMENTED CARBIDE CUTTING TOOLS CO., LTD., Hunan (CN)

(72) Inventors: Aisheng JIANG, Hunan (CN); Shequan WANG, Hunan (CN); Ping LI, Hunan (CN); Min LIU, Hunan (CN); Xingdong XIANG, Hunan (CN); Zhiwei ZHAO, Hunan (CN)

(73) Assignee: ZHUZHOU CEMENTED CARBIDE CUTTING TOOLS CO., LTD., Hunan (CN)

(21) Appl. No.: 17/266,630

(22) PCT Filed: Sep. 30, 2019
(86) PCT No.: PCT/CN2019/109463

§ 371 Date: Feb. 8, 2021

(30) Foreign Application Priority Data
Nov. 2, 2018 (CN) 201811301440.5

(51) Int. Cl. B23B 31/11; B23B 51/02

(52) U.S. Cl. CPC B23B 31/11; B23B 2251/02; B23B 51/02

(57) ABSTRACT

A drilling tool includes a cutting part and a clamping part. The cutting part includes a cutting portion and a connecting portion connected to a lower end of the cutting portion. The connecting portion has an outer peripheral surface, and the clamping part has an inner peripheral surface. A recess of the outer peripheral surface is spirally twisted into a protrusion of the inner peripheral surface in a direction of a central axis. In the process of clamping the cutting part on the clamping part, the outer peripheral surface and the inner peripheral surface fit together with a varying interference amount λ, which meets the following requirements: −0.1 mm≤λ≤0.05 mm.

### BACKGROUND

### Technical Field

The present invention relates to the field of drilling tool, in particular to a drilling tool with stable clamping.

### Description of Related Art

In drilling, in order to prolong service life of cutting portions, relatively precious cemented carbide or similar materials are usually used as tool materials. Such materials have high hardness, good wear resistance and considerable difficulty in machining, resulting in high material cost and machining cost of drilling tools. At present, commonly used drilling tools are generally composed of cutting parts and clamping parts. The cutting parts are made of cemented carbide or similar materials with high hardness and good wear resistance, while the clamping parts are made of elastic materials. When the cutting parts are worn out, the cutting parts can be replaced separately, which can reduce drilling cost. However, such drilling tools have poor locating accuracy, liability to fall off and short service life.

CN102015001011474 discloses a drilling tool, recess and protrusion fit is essentially clearance interference fit of form of thread, and in the process of twisting, clearance fit occurs earlier than interference fit, and finally the clearance fit occurs again. A negative clearance refers to an interference amount. In the case of thread interference clamping, although the thread interference clamping can be realized, it is difficult to accurately control interference size of pitch diameter of thread. At the same time, the thread interference occurs on both sides of the form of thread, resulting in small contact area, poor circumferential centering ability of a tool bit, and complete contact with an axial locating surface. During batch installation, it is hard to guarantee axial and circumferential runout accuracy of the tool bit, and the thread interference can only be used in clamping instead of centering.

### SUMMARY

The present invention provides a drilling tool that has advantages of stable clamping, fast assembly and disassembly, no axial looseness, high locating accuracy and effective prevention of falling off of cutting parts.

In order to solve the above technical problem, the present invention adopts the following technical solution.

A drilling tool with stable clamping comprises a cutting part and a clamping part. The cutting part comprises a cutting portion and a connecting portion connected to a lower end of the cutting portion. The connecting portion is provided with multiple accommodating grooves penetrating the cutting portion. The connecting portion is provided with an outer peripheral surface between the adjacent accommodating grooves. An axial locating surface for axial locating is provided at a connection between the cutting portion and the connecting portion. The clamping part comprises a shank portion and a clamping portion located at a front end of the shank portion. The clamping portion is provided with spiral grooves corresponding to the cuttings accommodating groove and extending to the shank portion. The clamping portion is provided with an inner peripheral surface for clamping the outer peripheral surface between the adjacent spiral grooves. A front end of the clamping portion is provided with an axial surface corresponding to the axial locating surface. The axial locating surface is in contact with the axial surface. A middle portion of the outer peripheral surface and a middle portion of the inner peripheral surface are respectively provided with a recess and a protrusion which are engaged with each other. The recess is spirally twisted into the protruding in a direction of a central axis. When the clamping part clamps the cutting part, the outer peripheral surface and the inner peripheral surface fit together with a varying interference amount λ, which meets the requirement: −0.1 mm≤λ≤0.05 mm.

As a further improvement of the above technical solution:

The recess is composed of two recess side surfaces and a recess bottom surface connected between the recess side surfaces. Each of the recess side surfaces is provided with an inner recess side surface at an end close to the recess bottom surface. The recess is composed of two protruding side surfaces and a protruding top surface connected between the two protruding side surfaces. Each of the protruding side surfaces is provided with an inner protruding side surface on a side close to the inner peripheral surface. When the clamping part clamps the cutting part, a clearance between the axial locating surface and the axial surface is τ1, and a clearance between the inner recess side surface of the recess side surface on a side away from the axial locating surface and the inner protruding side surface of the protruding side surface on a side away from the axial surface is τ2, which meets the following requirement: τ1=τ2=0.

When the clamping part clamps the cutting part, a clearance between the inner recess side surface at a side close to the axial locating surface and the inner protruding side surface at a side close to the axial surface is τ3, which meets the following requirement: 0 mm≤τ3≤0.1 mm.

The cutting portion is provided with a torque transmitting surface for circumferential locating, the clamping portion is provided with a circumferential surface for circumferential locating, and the torque transmitting surface is in contact with the circumferential surface. When the clamping part clamps the cutting part, a clearance between the torque transmitting surface and the circumferential surface is τ4, which meets the requirement: 0 mm≤τ4≤0.05 mm.

The connecting portion is provided with a bottom end surface which is perpendicular to the central axis on a side away from the cutting portion. An inclined notch is arranged between the recess and the bottom end surface. The clamping portion is provided with a groove bottom surface perpendicular to the central axis in a direction of a side close to the shank portion. A tail bump corresponding to the inclined notch is arranged between the protrusion and the groove bottom surface. When the clamping part clamps the cutting part, a clearance between the inclined notch and the tail bump is τ5, which meets the following requirement: 0.02 mm≤τ5≤0.1 mm.

In the direction of the central axis, a lead angle of the recess of the cutting part is α, which meets the following requirement: 8°≤α≤12°.

The recess side surface comprises a top recess side surface, and the top recess side surface is arranged close to the outer peripheral surface. Each of the recess side surfaces comprises a top protruding side surface, and the top protruding side surface is arranged close to the protruding top surface. When the clamping part clamps the cutting part, the top protruding side surface is not in contact with the recess, and the top recess side surface is not in contact with the protrusion.

The recess side surface also comprises an inner recess side surface, and the inner recess side surface is located between the top recess side surface and the recess bottom surface. The protruding side surface comprises an inner protruding side surface, and the inner protruding side surface is located between the top protruding side surface and the protruding top surface. A diameter of the outer peripheral surface of the cutting part is D, a radial depth of the inner recess side surface is L, a radial depth of the top recess side surface is L1, a radial depth of the inner protruding side surface is L′, and a radial depth of the top protruding side surface is L1′, which meets the following requirements: 0.02D≤L, L′≤0.15D, 0.003D≤L1, and L1′≤0.01D.

In a plane passing through the central axis, a distance from a projection line of the outer peripheral surface to the central axis is constant. In the process of twisting the outer peripheral surface of the cutting part into the inner peripheral surface of the clamping part, a variation in distance from a projection line of the inner peripheral surface to the central axis is ΔR, which meets the following requirements: 0<ΔR≤0.04 mm.

When the recess of the cutting part is completely twisted into the protrusion of the clamping part, a maximum circumferential twisting angle between the recess and the protrusion is γ, which meets the following requirement: 70°≤γ≤130°.

When the twisting angle is 0.4γ-0.65γ, a distance R from the projection line of the inner peripheral surface to the central axis has a minimum value in the plane passing through the central axis.

When the recess of the cutting part is twisted into the protrusion of the clamping part, the variation in distance ΔR changes linearly with increase of the twisting angle.

In the plane passing through the central axis, a distance R from the projection line of the inner peripheral surface to the central axis is constant. In the process of twisting the outer peripheral surface of the cutting part into the inner peripheral surface of the clamping part, in the plane passing through the central axis, a variation in distance from the projection line of the outer peripheral surface to the central axis is ΔR′, which meets the following requirement: 0<ΔR′≤0.04 mm.

When the recess of the cutting part is completely twisted into the protrusion of the clamping part, the maximum circumferential twisting angle between the recess and the protrusion is γ, which meets the following requirement: 70°≤γ≤130°.

When the twisting angle is 0.4γ-0.65γ, a distance R′ from the projection line of the inner peripheral surface to the central axis has a maximum value in the plane passing through the central axis.

When the recess of the cutting part is twisted into the protrusion of the clamping part, the variation in distance ΔR′ changes linearly with increase of the twisting angle.

Compared with the prior art, the present invention has the following advantages:

In the drilling tool with stable clamping of the present invention, the recess of the cutting part is spirally twisted into the protrusion of the clamping part, and interference fit occurs between the outer peripheral surface of the cutting part and the inner peripheral surface of the clamping part. The fit between the outer peripheral surface and the inner peripheral surface essentially refers to clearance interference fit between an inner hole wall and an outer cylinder. In the process of twisting, clearance fit occurs earlier than the interference fit, and finally the clearance fit occurs again. In this manner, the inner hole and the outer cylinder can be used in clamping and accurately centering, which can improve assembly accuracy, and reduce manufacturing difficulty of the recess and the protrusion. The clamping parts can not only quickly and conveniently complete clamping of the cutting part, but also effectively prevent the cutting part from loosening around the central axis.

In the drilling tool with stable clamping of the present invention, in the direction parallel to the central axis, the clearance between the axial locating surface and the axial surface is τ1, and the clearance between the recess side surface on the side away from the axial locating surface and the protruding side surface on the side away from the axial surface is τ2, which should meet the following requirement: τ1=τ2=0. The clamping part and the cutting part clamp the cutting part up and down simultaneously without any clearance on the axial locating surface and the inner recess side surface, so that the cutting part can be positioned accurately in the direction of the central axis and will not come loose in the direction of the central axis in the cutting process, which improves cutting stability.

In the drilling tool with stable clamping of the present invention, the cutting part and the clamping part are respectively provided with a torque transmitting surface and a circumferential surface for transmitting circumferential load. In the direction of rotation along the central axis, the clearance between the torque transmitting surface and the circumferential surface is τ4, with 0 mm≤τ4≤0.05 mm. The clamping part forms over-locating clamping to the cutting part, resulting in good locating strength, accuracy and impact resistance. Precise and accurate design of the clearance τ4 between the torque transmitting surface and the circumferential surface can not only effectively reduce manufacturing difficulty of an over-locating structure, but also use axial micro deformation of the protrusion (generally less than 0.004 mm) to increase contact area between the recess and the protrusion and realize the complete contact between the torque transmitting surface and the circumferential surface, thus improving the clamping stability and clamping repeatability of the cutting part, reducing cutting vibration and improving surface quality of the hole while greatly improving the service life of cutting part.

In the drilling tool with stable clamping of the present invention, the top protruding side surface is not in contact with the recess, and the top recess side surface is not in contact with the protrusion, so that the protrusion can only be in contact with the inner recess side surface, which can maximize effective contact length and contact strength of the recess and the protrusion, prevent the cutting part from falling off from the clamping part, and improve stress capacity of an interface, thus prolonging the service life of the cutting part.

In the drilling tool with stable clamping of the present invention, by precisely designing the lead angle α at which the recess of the cutting part is spirally twisted into the protrusion of the clamping part and the clearance τ4 between the torque transmitting surface and the circumferential surface, even if manufacturing tolerance of the cutting part is inevitable, when the cutting parts are assembled interchangeably in batches, the axial locating surface, the inner recess side surface and the torque transmitting surface of the cutting part are still in full contact with the clamping part, which greatly ensures interchangeability and performance stability of different cutting parts.

### BRIEF DESCRIPTION OF THE DRAWINGS

FIG. 1 is a 3D structure diagram of an embodiment of the present invention.

FIG. 2 is a front view of an embodiment of the present invention.

FIG. 3 is a left view of an embodiment of the present invention.

FIG. 4 is A-A sectional view of FIG. 2.

FIG. 5 is B-B sectional view of FIG. 2.

FIG. 6 is a 3D structure diagram of a cutting part in an embodiment of the present invention.

FIG. 7 is a front view of a cutting part in an embodiment of the present invention.

FIG. 8 is a C-C sectional view of FIG. 7.

FIG. 9 is a D-D sectional view of FIG. 7.

FIG. 10 is a 3D structure diagram of a clamping part in an embodiment of the present invention.

FIG. 11 is a side view of a clamping part in an embodiment of the present invention.

FIG. 12 is an F-F sectional view of FIG. 11.

### REFERENCE NUMERALS IN THE DRAWINGS

1. Cutting part; 11. Cutting portion; 111. Cutting surface; 112. Axial locating surface; 113. Torque transmitting surface; 12. Connecting portion; 121. Bottom end surface; 13. Outer peripheral surface; 14. Cuttings accommodating groove; 2. Clamping part; 21. Clamping portion; 211. Groove top surface; 212. Axial surface; 213. Groove bottom surface; 214. Circumferential surface; 215. Bottom recess; 22. Shank portion; 23. Inner peripheral surface; 24. Central axial; 25. Spiral groove; 3. Recess; 31. Recess side surface; 311. Inner recess side surface; 312. Top recess side surface; 32. Recess bottom surface; 4. Protrusion; 41. Protruding side surface; 411. Inner protruding side surface; 412. Top protruding side surface; 42. Protruding top surface; 5. Inclined notch; 51. Inclined side surface; 52. Inclined bottom surface; 6. Tail bump; 61. Tail side surface; 62. Tail top surface.

### DESCRIPTION OF THE EMBODIMENTS

The present invention will be further explained in detail in combination with the drawings and specific embodiments.

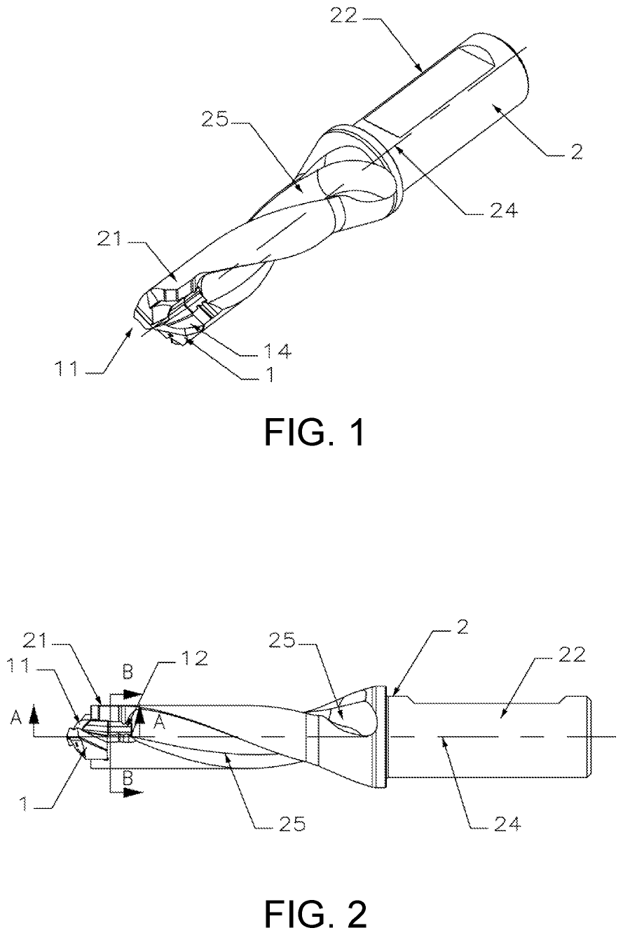

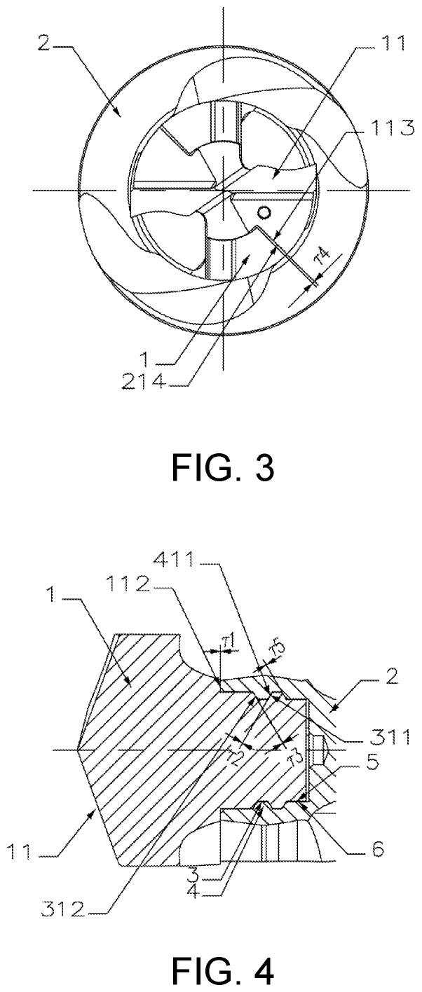

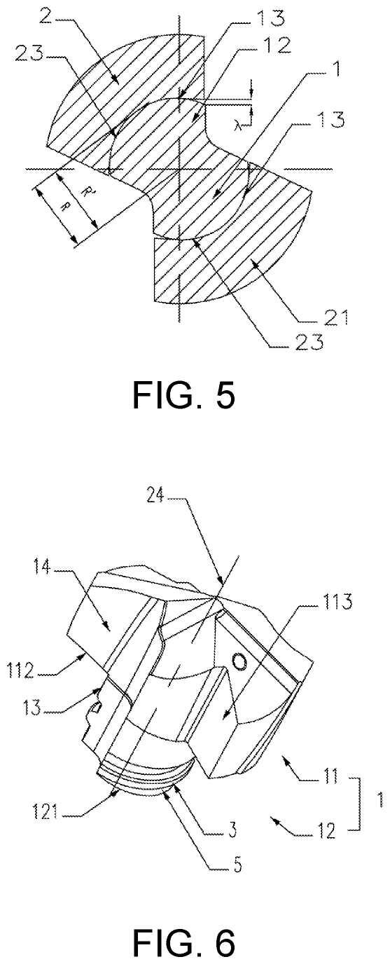

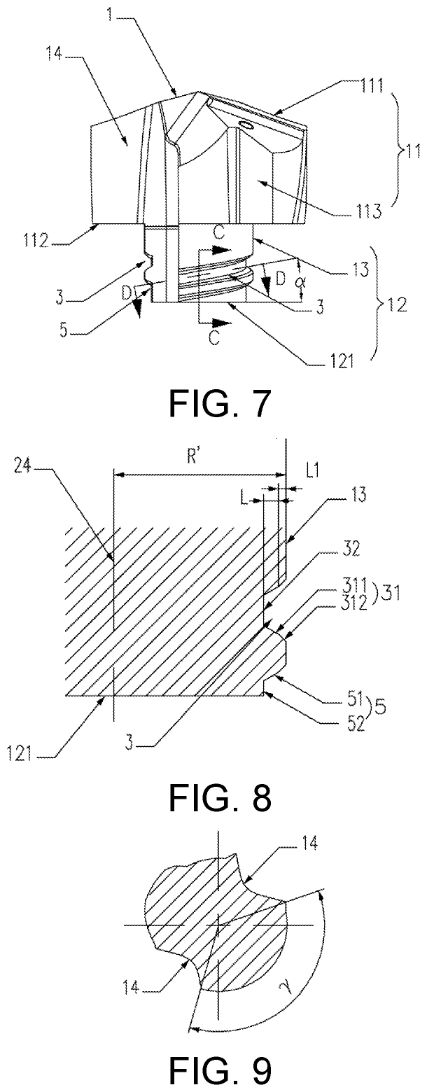

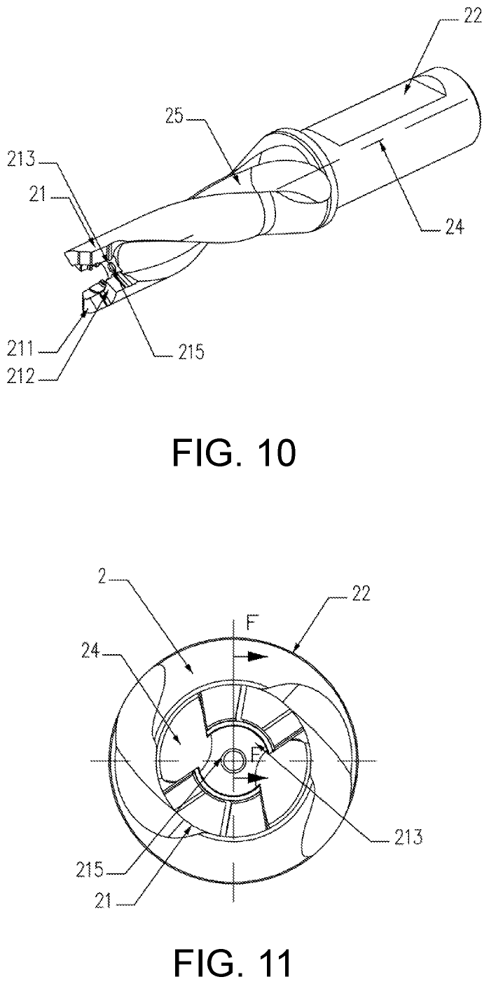

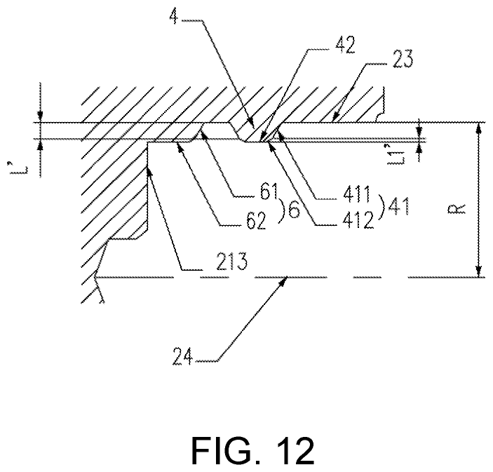

FIG. 1 to FIG. 12 show an embodiment of a drilling tool with stable clamping of the present invention. The drilling tool with stable clamping comprises a cutting part 1 and a clamping part 2, and the cutting part 1 and the clamping part 2 are symmetrical with respect to a central axis 24. The cutting part 1 comprises a cutting portion 11 and a connecting portion 12 connected to a lower end of the cutting portion 11, and the clamping part 2 comprises a shank portion 22 and two clamping portions 21 at a front end of the shank portion 22. The cutting portion 11 of the cutting part 1 is provided with two cutting edges, and the connecting portion 12 is provided with multiple accommodating grooves 14 penetrating the cutting portion 11. The connecting portion 12 is provided with an outer peripheral surface 13 between the adjacent accommodating grooves 14, the clamping portion 21 is provided with spiral grooves 25 corresponding to the cuttings accommodating groove 14 and extending to the shank portion 22, and the clamping portion 21 is provided with an inner peripheral surface 23 for clamping the outer peripheral surface 13 between the adjacent spiral grooves 25. Middle portions and bottoms of the outer peripheral surface 13 are respectively provided with a recess 3 and an inclined notch 5, and middle portions and bottoms of the inner peripheral surface 23 are respectively provided with a protrusion 4 and a tail bump 6. An axial locating surface 112 is provided at a junction between the cutting portion 11 and the connecting portion 12, the clamping portion 21 is provided with an axial surface 212 corresponding to the axial locating surface 112, and a clearance is arranged between a bottom end surface 121 of the connecting portion 12 of the cutting part 1 and a groove bottom surface 213 of the clamping portion 21 of the clamping part 2. The recess 3 spirally rotates around the central axis 24 of the clamping part 2 to accommodate the protrusion 4 to engagement to achieve complete clamping of the cutting part 1 on the clamping part 2. In order to ensure that the clamping part 2 forms high-precision and high-strength clamping on the cutting part 1, and ensure that the cutting part 1 does not fall off from the clamping part 2 during use, the outer peripheral surface 13 and the inner peripheral surface 23 match with a varying interference amount 2 in the complete clamping process, which should meet the following requirement: −0.1 mm≤λ≤0.05 mm.

In the clamping process, the clamping process is clearance fit→clearance decrease→interference fit→interference increase→maximum interference→clearance fit. A change rule of the interference amount λ is from the minimum value λₘᵢₙ (−0.1 mm) to the maximum value λₘₐₓ (0.05 mm). After the complete clamping, the interference amount 2 returns to the minimum value λₘᵢₙ.

In the present embodiment, in order to improve the clamping effect of the clamping part 2 on the cutting part 1, when the cutting part 1 is twisted into the clamping part 2, the interference amount λ of the clamping part changes in a range of −0.05 mm and 0.03 mm in the process from the clearance to the interference. At the beginning of the clamping, the interference amount λ is −0.1 mm (at this time, the clamping part 2 and the cutting part 1 are in clearance fit), and then the interference amount λ gradually increases to 0.05 mm. In order to ensure that the inner peripheral surface 23 of the clamping part 2 can stably and elastically clamp the outer peripheral surface 13 of the cutting part 1, a bottom recess 215 is provided on the groove bottom surface 213 of the clamping portion 21 of the clamping part 2.

A front end of the cutting portion 11 is provided with a cutting surface 111, a rear end of the connecting portion 12 is provided with a bottom end surface 121, and an axial locating surface 112 for axial locating is provided at a junction between the cutting portion 11 and the connecting portion 12. The two clamping parts 21 are arranged opposite to each other along the central axis 24, a middle portion thereof is provided with a mounting groove, a front end of the clamping portion 21 is provided with a groove top surface 211, and a rear end of the mounting groove is provided with a groove bottom surface 213. In the direction of the central axis 24, a torque transmitting surface 113 for circumferential locating is arranged between the cutting surface 111 and the locating surface 112, and the clamping portion 21 is provided with a circumferential surface 214 corresponding to the torque transmitting surface 113 between the groove top surface 211 and the axial surface 212.

The recess 3 in the middle of the outer peripheral surface 13 of the connecting portion 12 of the cutting part 1 is composed of two recess side surfaces 31 and one recess bottom surface 32. Each of the recess side surfaces 31 is composed of an inner recess side surface 311 and a top recess side surface 312. The inner recess side surface 311 is arranged close to the recess bottom surface 32, and the top recess side surface 312 is arranged close to the outer peripheral surface 13.

The protrusion 4 in the middle of the inner peripheral surface 23 of the clamping portion 21 is composed of two protruding side surfaces 41 and a protruding top surface 42. Each of the protruding side surfaces 41 is composed of an inner protruding side surface 411 and a top protruding side surface 412, the inner protruding side surface 411 is arranged close to the inner peripheral surface 23, and the top protruding side surface 412 is arranged close to the protruding top surface 42.

In a plane passing through the central axis 24, an included angle between the two top recess side surfaces 312 on the recess 3 is greater than that between the two inner recess side surfaces 311, an included angle between the two top protruding side surfaces 412 on the protrusion 4 is greater than that between the corresponding two inner protruding side surfaces 411, and the included angle between the two inner recess side surfaces 311 is essentially equal to that between the two inner protruding side surfaces 411.

In order to make the clamping part 2 form over-locating clamping to the cutting part 1 and improve stability and impact resistance of the clamping, when the clamping part 2 completely clamps the cutting part 1, a clearance between the axial locating surface 112 and the axial surface 212 is τ1, and a clearance between the inner recess side surface 311 on a side away from the axial locating surface 112 and the inner protruding side surface 411 on a side away from the axial surface 212 is τ2, which should meet the following requirement: τ1=τ2=0. That is, the inner recess side surface 311 on the side away from the axial locating surface 112 is in contact with the inner protruding side surface 411 on the side away from the axial surface 212, and the axial locating surface 112 is in contact with the axial surface 212.

On the plane in the direction of the central axis 24, an inclined notch 5 is arranged between the recess 3 of the cutting portion 11 and the bottom end surface 121, the clamping portion 21 is provided with a tail bump 6 corresponding to the inclined notch 5, and the tail bump 6 is arranged between the protrusion 4 and the groove bottom surface 213. The inclined notch 5 is composed of one inclined side surface 51 and one inclined bottom surface 52, the tail bump 6 is composed of a tail side surface 61 and a tail top surface 62, the inclined side surface 51 is not in contact with the inner tail side surface 61, and a clearance between the inner recess side surface 311 on the side close to the axial locating surface 112 and the inner protruding side surface 411 on the side close to the axial surface 212 is τ3, which should meet the following requirement: 0 mm≤τ3≤0.03 mm.

A lead angle of the recess side surface 31 of the cutting part 1 is α in the direction of the central axis 24, which should meet the following requirement: 8°≤α≤12°.

When the torque transmitting surface 113 is in contact with the circumferential surface 214, and the clamping part 2 completely clamps the cutting part 1, a clearance between the torque transmitting surface 113 and the circumferential surface 214 is τ4, which should meet the following requirement: 0 mm≤τ4≤0.05 mm.

The inner protruding side surface 411 on the side close to the axial surface 212 is in fit with the inner recess side surface 311 on the side close to the axial locating surface 112, while the top protruding side surface 412 is not in contact with the inner recess side surface 311 of the recess 3. On the plane in the direction of the central axis 24, a clearance between the inclined notch 5 and the tail bump 6 is τ5, which should meet the following requirement: 0.02 mm≤τ5≤0.1 mm.

The recess bottom surface 32 is not in contact with the protruding top surface 42. In order to simplify the structure of the clamping part 2 to the cutting part 1 and reduce manufacturing difficulty, in the plane passing through the central axis 24, a distance from a projection line of the outer peripheral surface 13 to the central axis 24 is constant. In the process of twisting the recess 3 of the cutting part 1 into the protrusion 4 of the clamping part 2, a distance R′ from a projection line of the inner peripheral surface 23 on the connecting portion 12 of the cutting part 1 to the central axis 24 changes linearly with the increase of a twisting angle with variation being ΔR′, which should meet the following requirement: 0<ΔR′≤0.04 mm. In order to ensure that the cutting part 1 and the clamping part 2 have good mounting interchangeability and accurate clamping locating, in the present embodiment, ΔR=0.025 mm.

The top protruding side surface 412 is not in contact with the recess 3, and the top recess side surface 312 is not in contact with the protrusion 4. In order to ensure the locating accuracy and clamping strength of the clamping part 2 to the cutting part 1, and to eliminate the influence of failure to perform back gouging for the recess 3 of the cutting part 1 and the protrusion 4 of the clamping part 2 on the locating and clamping, a diameter of the outer peripheral surface 13 of the cutting part 1 is D, a radial depth of the inner recess side surface 311 is L, a radial depth of the top recess side surface 312 is L1, and a radial depth of the inner protruding side surface 411 is L′, and a radial depth of the top protruding side surface 412 is L1′, which should meet the following requirements: 0.02D≤L, L′≤0.15D, 0.003D≤L1, and L1′≤0.01D. In the present embodiment, in order to ensure full contact and locating strength between the inner protruding side surface 411 and the inner recess side surface 311, L1=0.06D, and L2=0.07D.

When the recess 3 of the cutting part 1 is completely twisted into the protrusion 4 of the clamping part 2, a maximum circumferential twisting angle γ of spirally rotating the recess 3 and the protrusion 4 around the central axis 24 should meet the following requirement: 70°≤γ≤130°. In order to ensure that the cutting part 1 can be easily assembled and disassembled and that the clamping part 2 has enough clamping strength to the cutting part 1, in the present embodiment, γ=100°.

In order to ensure that a clamping part 2 can clamp different cutting parts 1, and the cutting parts 1 have good interchangeability and connection strength, when the actual twisting angle is 0.4γ-0.65γ in the plane passing through the central axis 24, the distance R′ from the projection line of the outer peripheral surface 13 to the central axis 24 has a minimum value (the interference amount is maximum when the outer peripheral surface has a minimum radius). In order to ensure mounting convenience and high location strength, in the present embodiment, when the actual twisting angle is 0.45γ-0.55γ, the distance R′ from the projection line of the outer peripheral surface 13 to the central axis 24 has the minimum value.

In the present embodiment, in the process of twisting the recess 3 of the cutting part 1 into the protrusion 4 of the clamping part 2, in the plane passing through the central axis 24, the distance from the projection line of the outer peripheral surface 13 to the central axis 24 is constant, while the distance R from the projection line of the inner peripheral surface 23 to the central axis 24 is a variation, which aims to reduce the manufacturing difficulty. The invention is not limited to this, according to the different manufacturing difficulties and design methods, the distance from the projection line of the inner peripheral surface 23 to the central axis 24 can be constant, the distance R′ from the projection line of the outer peripheral surface 13 to the central axis 24 changes linearly with the increase of the twisting angle in the process of twisting the recess 3 of the cutting part 1 into the protrusion 4 of the clamping part, and the variation is ΔR′ and should meet the following requirement: 0≤ΔR′≤0.04 mm.

In addition, according to the different design and manufacturing processes, the distance from the projection line of the outer peripheral surface 13 of the cutting part 1 to the central axis 24 and the distance from the projection line of the inner peripheral surface 23 of the clamping part 2 to the central axis 24 can be designed to be varying to ensure the interference amount.

In the above embodiments, each cutting part 1 is provided with two cutting edges. The invention is not limited to this. According to different applications and different working parameters, a single cutting part 1 can be provided with three or more cutting edges. Meanwhile, in the above embodiments, the distance from the outer peripheral surface 13 on the connecting portion 12 of the cutting part 1 to the central axis 24 is R′. In the process of twisting the recess 3 of the cutting part 1 into the protrusion 4 of the clamping part 2, the variations ΔR and ΔR′ change linearly with the increase of the twisting angle. The present invention is not limited to this. In order to improve operation convenience of twisting the cutting part 1 into the clamping part 2, the variations ΔR and ΔR′ can also be designed as quadratic curves and other changes.

Although the present invention has been disclosed as above in the preferred embodiments, they are not intended to limit the present invention. Any person skilled in the art may make many possible variations and modifications or make equivalent embodiments with equivalent changes to the technical solution of the present invention utilizing the disclosed technical contents without departing from the scope of the technical solution of the present invention. Therefore, all the contents without departing from the technical solution of the present invention, and any simple amendments, equivalent variations and modifications made to the described embodiments based on the technical spirit of the present invention, would be incorporated in the protection scope of the technical solution of the present invention.

1. A drilling tool, comprising a cutting part and a clamping part, wherein the cutting part comprises a cutting portion and a connecting portion connected to a lower end of the cutting portion, the connecting portion is provided with a plurality of accommodating grooves penetrating the cutting portion, the connecting portion is provided with an outer peripheral surface between the adjacent accommodating grooves, an axial locating surface for axial locating is provided at a connection between the cutting portion and the connecting portion, the clamping part comprises a shank portion and a clamping portion located at a front end of the shank portion, the clamping portion is provided with spiral grooves corresponding to the accommodating groove and extending to the shank portion, the clamping portion is provided with an inner peripheral surface for clamping the outer peripheral surface between the adjacent spiral grooves, a front end of the clamping portion is provided with an axial surface corresponding to the axial locating surface, the axial locating surface is in contact with the axial surface, a middle portion of the outer peripheral surface and a middle portion of the inner peripheral surface are respectively provided with a recess and a protrusion which are engaged with each other, the recess is spirally twisted into the protrusion in a direction of a central axis, when the clamping part clamps the cutting part, the outer peripheral surface and the inner peripheral surface fit together with a varying interference amount λ, which meets: −0.1 mm≤λ≤0.05 mm.

2. The drilling tool as recited in claim 1, wherein the recess is composed of two recess side surfaces and a recess bottom surface connected between the recess side surfaces, each of the recess side surfaces is provided with an inner recess side surface at an end close to the recess bottom surface, the protrusion is composed of two protruding side surfaces and a protruding top surface connected between the two protruding side surfaces, each of the protruding side surfaces is provided with an inner protruding side surface on a side close to the inner peripheral surface, when the clamping part clamps the cutting part, a clearance between the axial locating surface and the axial surface is τ1, and a clearance between the inner recess side surface of the recess side surface on a side away from the axial locating surface and the inner protruding side surface of the protruding side surface on a side away from the axial surface is τ2, which meets: τ1=τ2=0.

3. The drilling tool as recited in claim 2, wherein when the clamping part clamps the cutting part, a clearance between the inner recess side surface at a side close to the axial locating surface and the inner protruding side surface at a side close to the axial surface is τ3, which meets: 0 mm≤τ3≤0.1 mm.

4. The drilling tool as recited in claim 3, wherein the cutting portion is provided with a torque transmitting surface for circumferential locating, the clamping portion is provided with a circumferential surface for circumferential locating, and the torque transmitting surface is in contact with the circumferential surface, when the clamping part clamps the cutting part, a clearance between the torque transmitting surface and the circumferential surface is τ4, which meets: 0 mm≤τ4≤0.05 mm.

5. The drilling tool as recited in claim 4, wherein the connecting portion is provided with a bottom end surface which is perpendicular to the central axis on a side away from the cutting portion, an inclined notch is arranged between the recess and the bottom end surface, the clamping portion is provided with a groove bottom surface perpendicular to the central axis in a direction of a side close to the shank portion, a tail bump corresponding to the inclined notch is arranged between the protrusion and the groove bottom surface, when the clamping part clamps the cutting part, a clearance between the inclined notch and the tail bump is τ5, which meets: 0.02 mm≤τ5≤0.1 mm.

6. The drilling tool as recited in claim 1, wherein in the direction of the central axis (24), a lead angle of the recess of the cutting part is α, which meets: 8°≤α≤12°.

7. The drilling tool as recited in claim 2, wherein each of the recess side surfaces comprises a top recess side surface, and the top recess side surface is arranged close to the outer peripheral surface, each of the protruding side surfaces comprises a top protruding side surface, and the top protruding side surface is arranged close to the protruding top surface, when the clamping part clamps the cutting part, the top protruding side surface is not in contact with the recess, and the top recess side surface is not in contact with the protrusion.

8. The drilling tool as recited in claim 7, wherein the inner recess side surface is located between the top recess side surface and the recess bottom surface, the inner protruding side surface is located between the top protruding side surface and the protruding top surface, a diameter of the outer peripheral surface of the cutting part is D, a radial depth of the inner recess side surface is L, a radial depth of the top recess side surface is L1, a radial depth of the inner protruding side surface is L′, and a radial depth of the top protruding side surface is L1′, which meets: 0.02D≤L, L′≤0.15D, 0.003D≤L1, and L1′≤0.01D.

9. The drilling tool as recited in claim 8, wherein in a plane passing through the central axis, a distance from a projection line of the outer peripheral surface to the central axis is constant, in the process of twisting the outer peripheral surface of the cutting part into the inner peripheral surface of the clamping part, a variation in distance from a projection line of the inner peripheral surface to the central axis is ΔR, which meets: 0<ΔR≤0.04 mm.

10. The drilling tool as recited in claim 9, wherein when the recess of the cutting part is completely twisted into the protrusion of the clamping part, a maximum circumferential twisting angle between the recess and the protrusion is γ, which meets: 70°≤γ≤130°.

11. The drilling tool as recited in claim 10, wherein when the twisting angle is 0.4γ-0.65γ, a distance from the projection line of the inner peripheral surface to the central axis has a minimum value in the plane passing through the central axis.

12. The drilling tool as recited in claim 11, wherein when the recess of the cutting part is twisted into the protrusion of the clamping part, the variation in distance changes linearly with increase of the twisting angle.

13. The drilling tool as recited in claim 8, wherein in the plane passing through the central axis, a distance from the projection line of the inner peripheral surface to the central axis is constant, in the process of twisting the outer peripheral surface of the cutting part into the inner peripheral surface of the clamping part, in the plane passing through the central axis, a variation in distance from the projection line of the outer peripheral surface to the central axis is ΔR′, which meets: 0<ΔR′≤0.04 mm.

14. The drilling tool as recited in claim 13, wherein when the recess of the cutting part is completely twisted into the protrusion of the clamping part, a maximum circumferential twisting angle between the recess and the protrusion is γ, which meets: 70°≤γ≤130°.

15. The drilling tool as recited in claim 14, wherein when the twisting angle is 0.4γ-0.65γ, a distance from the projection line of the outer peripheral surface to the central axis has a maximum value in the plane passing through the central axis.

16. The drilling tool as recited in claim 15, wherein when the recess of the cutting part is twisted into the protrusion of the clamping part, the variation in distance changes linearly with increase of the twisting angle.
